(19) United States
(12) Patent Application Publication
(10) Pub. No.: US 2009/0173175 A1
(43) Pub. Date: Jul. 9, 2009

(54) Double-clutch gearbox

(76) Inventor: Pascal Thery, Amiens (FR)

Correspondence Address: TROP, PRUNER & HU, P.C., 1616 S. VOSS ROAD, SUITE 750, HOUSTON, TX, 77057-2631, US

(21) Appl. No.: 11/920,485

(22) PCT Filed: Apr. 26, 2006
(86) PCT No.: PCT/FR2006/000938

§ 371 Date: Feb. 23, 2009

(30) Foreign Application Priority Data
May 20, 2005 (FR) 0505093

(51) Int. Cl. B60W 10/02; F16H 3/093

(52) U.S. Cl. 74/331; 477/175

(57) ABSTRACT

The invention concerns a gearbox comprising two primary shafts (2, 4), each connected to a clutch (C1, C2) coupled to an engine, and at least one secondary shaft (10), each primary shaft (2, 4) capable of being rotatably coupled with a secondary shaft (10), by the engagement of two ratios which in direct use constitute two gears of the gearbox. The invention is characterized in that the primary shafts can be rotatably linked with each other along a common rotational direction, through the engagement of two transfer links (T1, T2) arranged on the auxiliary shaft (30), each being implemented by the engagement of a single synchronizing sleeve (16, 22), the first transfer link (T1) providing from the rotation of the first primary shaft (2) a reduced speed of the second primary shaft (4), the second transfer link (T2) providing a greater reduction of the speed of the second primary shaft (4).

This invention involves a gearbox used for the transmission system of an automotive vehicle.

A kind of known automatic gearbox with dual clutch includes two input primary shafts each linked to the shaft of an engine via a clutch that can operate dry or in oil. Each primary shaft transfers the movement received from the engine via various reduction ratios defining each a reduction speed, called hereafter speed, to one or several secondary shafts linked to the output of the gearbox to the driving wheels. Each speed is engaged via the clutching of a pinion after the synchronisation of the movement, taken in the sequence of a rising speed increase they are alternatively arranged on one primary shaft and on the other.

The starting from rest of the vehicle is done by engaging the ratio giving the highest reduction linked to one primary shaft, then by gradually tightening a first clutch driving this shaft to transfer the torque. The shifting from the first to the second ratio is performed by engaging the second ratio arranged on the second primary shaft, then by simultaneously closing the second clutch and opening the first one, the engine torque is transferred continuously from the first to the second ratio. The other speed shifts are achieved in the same way without breaking the torque transfer, which provides a good comfort and high performances.

The clutch commands and the gear shifting devices include actuators controlled by a control unit that uses information on the engine and vehicle operation, and on the driver requests.

An improvement of such a kind of gearbox is described in the document DE-A1-10015336. The movement of an engine is transferred by two clutches to two primary shafts arranged on a same axis, each one can drive through two ratios a secondary shaft to achieve four speeds. An auxiliary shaft shifted sideways supports a power transfer that can link the two primary shafts together in rotation with a given speed reduction, a sliding sleeve acting on a synchroniser engages it. The clutch of a primary shaft being closed, the movement is transferred via the power transfer to the other primary shaft then to the secondary shaft via one of the ratios, the speed reduction of the power transfer being combined to the one of the used ratio to achieve an additional speed.

This power transfer is used to increase the speed reduction of the first ratio which ends up in a first speed for the starting from rest of the vehicle, and to rise the speed increase of the last ratio which ends up in a sixth speed.

However, this device by only adding two speeds on each side of the ratios' range, provides few additional possibilities and badly fulfils the requirements of a modern realisation for which it is wished to increase the number of speeds with a set of higher speed rather close. In addition, it is wished to keep lower speeds rather spaced.

This invention especially aims to avoid these drawbacks and to provide a simple, efficient and cost-effective solution to the above-mentioned problem. Its object is a gearbox achieving some speed changes without torque break, which offers a wider choice of speeds while keeping a reduced number of pinions, a good compactness and reduced costs.

To that end, it offers a gearbox including a first and a second primary shaft using a common axis, respectively linked to a first and second coupling clutch of an engine, and at least a secondary shaft linked to an output device of the gearbox, the second primary shaft can be linked in rotation to a secondary shaft by the engagement of a first and third ratio, the first primary shaft can be linked in rotation to a secondary shaft by the engagement of a second and fourth ratio, these directly used ratios achieving four speeds of the gearbox, and following their order successively achieving a higher and higher speed increase of the output component's speed, characterised in that the primary shafts can be connected in rotation together according to a same rotational direction thanks to the engagement of two power transfers, each one being activated by the engagement of a single synchronisation sleeve, the first power transfer achieving from a rotation of the first primary shaft a speed reduction of the second primary shaft, the second power transfer achieving a bigger speed reduction of the second primary shaft.

A main advantage of the gearbox following the invention is that it allows to add further speeds at begin and end of the range of four speed directly supplied by the four ratios, which allows by using several times the power transfer in combination with various ratios to achieve a series of speeds with a sufficient gear range, while keeping a good compactness and a limited number of components.

The second power transfer preferably provides a speed reduction at least twice higher than the one provided by the first power transfer.

The two power transfers are usefully combined with the fourth ratio to achieve respectively a first additional speed providing a high increase of the rotation speed, and a second additional speed providing a higher speed increase than the first speed.

For an indirect shift from the first additional speed to the second additional speed, the engine torque can be switched from one clutch to the other for a transient operation through the directly used fourth ratio, then the first power transfer is disengaged, the second power transfer is engaged, and finally the engine torque is switched back between the clutches the other way round, the engine being able to permanently supply a driving torque to the driving wheels.

For a direct shift from the first additional speed to the second additional speed, the clutch transferring the torque can also be opened, then the first power transfer is disengaged, the second power transfer is engaged, and finally the same clutch is closed again.

A shift from the directly used fourth ratio or from the first additional speed, to the second additional speed can be achieved from a given vehicle speed, when the driver has released the throttle.

The two power transfers are usefully combined with the first ratio to achieve respectively a first additional speed providing a high speed reduction and a second additional speed providing a higher speed reduction than the first one.

The vehicle driving in the directly used first ratio, the first additional speed can be engaged when the vehicle speed decreases below a given threshold, the second additional speed being engaged when the vehicle is almost at standstill.

On the other hand, the third ratio can be used in combination with the first power transfer so to providing an additional intermediate speed between the directly used second and third ratio, the shift process from the second ratio to the intermediate speed successively including following operations, the third ratio is engaged, the engine torque is switched from the first primary shaft to the second primary shaft by simultaneous at least partial closing of the clutch of the second primary shaft and opening of the clutch of the first primary shaft, the reduction ratio of the first primary shaft is disengaged, the power transfer is engaged and, finally, the engine torque is switched back from the second primary shaft to the first one by the simultaneous closing of the first clutch and opening of the second clutch.

According to a characteristic of the invention, the external primary shaft including a longitudinal boring supports the driving pinions of the first and third ratio, the second internal primary shaft going through the external primary shaft supports the driving pinions of the second and fourth ratio.

The synchronisation sleeves supported by the auxiliary shaft and achieving the engagement of the power transfers can be laterally aligned with the external primary shaft.

The driving pinion from the second ratio can be used to drive the auxiliary shaft, the driving pinion from the third ratio can possibly be used to achieve the second power transfer.

As a variant, the gearbox can include a first secondary shaft driven by the first and the third ratio, and a second secondary shaft driven by the second and the fourth ratio.

According to a special layout, the gearbox is axially fixed at the end of an engine, this system being transversally installed between the front driving wheels of a vehicle.

According to another special layout, the secondary shaft is axially aligned with the primary shafts.

A better understanding of the invention and a clearer vision of some other characteristics and advantages will derive from the reading of the detailed description hereafter, given as an example and performed with reference to the attached drawings in which:

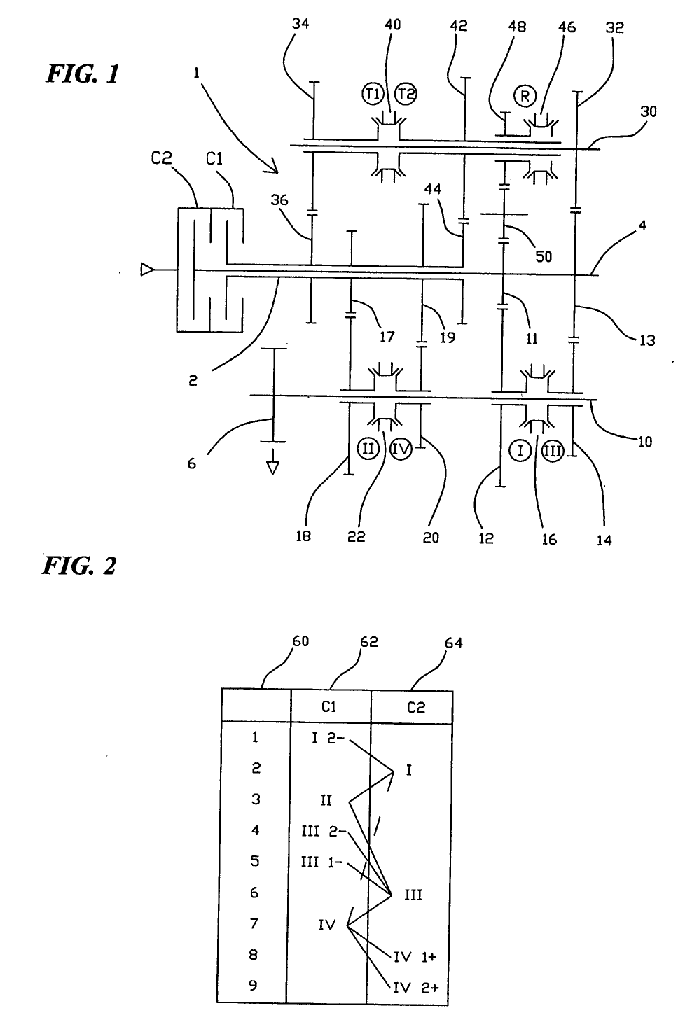

the FIG. 1 is a diagram of a gearbox according to the invention;

the FIG. 2 is a table presenting an operation of the gearbox;

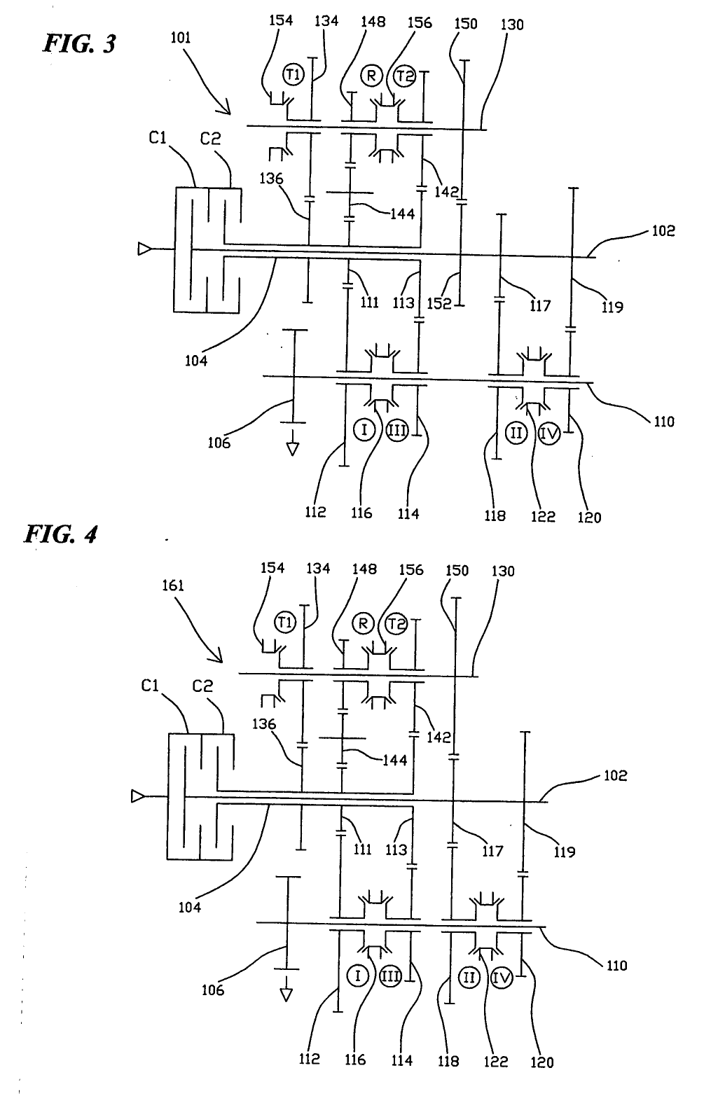

the FIG. 3 is a diagram of a gearbox according to a first variant;

the FIG. 4 is a diagram of a gearbox according to a second variant;

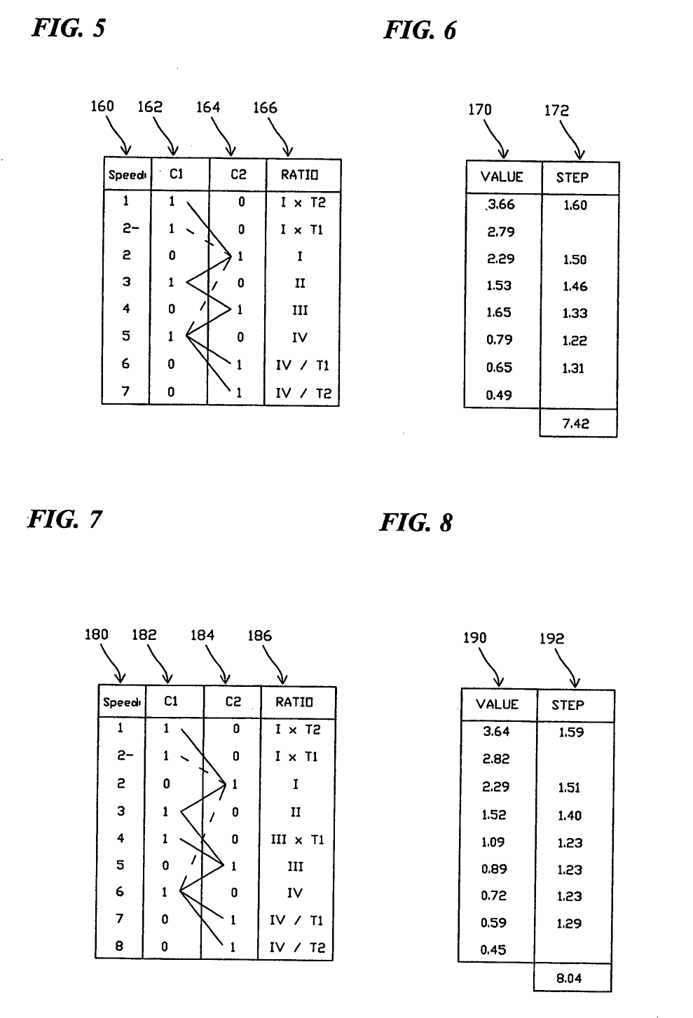

the FIG. 5 is a table presenting a first operating variant;

the FIG. 6 is a table presenting some examples of values for the first operating variant;

the FIG. 7 is a table presenting a second operating variant;

the FIG. 8 is a table presenting some examples of values for the second operating variant;

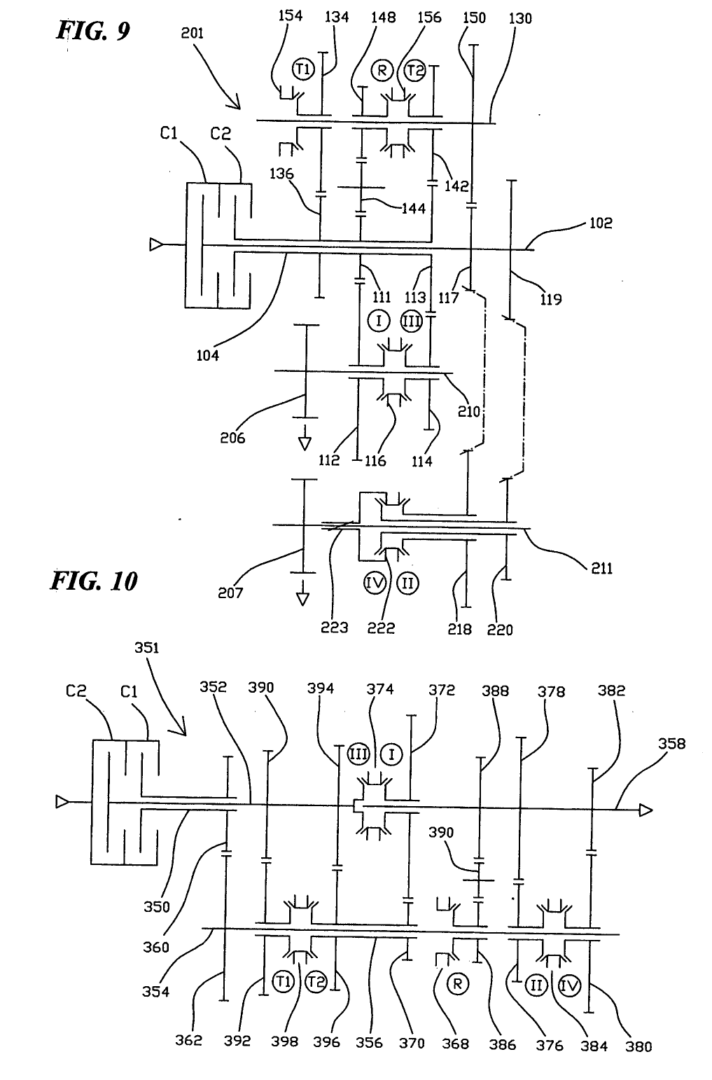

the FIG. 9 is a diagram of a gearbox according to a third variant;

the FIG. 10 is a diagram of a gearbox according to a fourth variant;

The FIG. 1 represents a gearbox 1 receiving the movement from a non represented motorization that drives clutches C1 and C2, including arranged according to a common axis a first clutch C1 that drives a hollow or external primary shaft 2 including a longitudinal boring, and juxtaposed to this first clutch a second clutch C2 that drives a second full or internal primary shaft 4 going through the inside of the external primary shaft 2. A secondary shaft 10 receives the movement coming from the primary shafts and transfers it to the driving wheels of the vehicle via an output pinion 6 usually connected to a differential system included in the gearbox. This output pinion 6 is placed at the end of the secondary shaft 10 on clutch side.

The internal primary shaft 4 can drive the secondary shaft 10 via a first ratio called ratio I, including a driving pinion 11 connected to the internal primary shaft 4 in gear with a driving pinion 12 supported by the secondary shaft 10, and via a third ratio called ratio III, including a driving pinion 13 in gear with a driving pinion 14 also supported by the secondary shaft. Each one of these ratios is engaged by connecting the driven pinion to the secondary shaft 10 via the displacement of a sliding sleeve 16 axially located between both and including synchronisation and clutching devices to its ends.

The external primary shaft 2 also can drive the secondary shaft 10 via a second ratio called ratio II, including a driving pinion 17 connected to the external primary shaft 2 in gear with a driving pinion 18 supported by the secondary shaft 10, and via a fourth ratio called ratio IV, including a driving pinion 19 in gear with a driving pinion 20 also supported by the secondary shaft. Each one of these ratios is engaged by connecting the driven pinion to the secondary shaft 10 via the displacement of a sliding sleeve 22 axially located between both.

The four secondary shaft ratios indicated as I, II, III and IV successively achieve a decreasing speed reduction, which provides the secondary shaft 10 with a higher and higher speed.

A parallel auxiliary shaft 30 shifted laterally towards the primary shafts 2, 4 is connected in rotation on a permanent way to the internal primary shaft 4 via a pair of pinions formed with a pinion 32 connected to the auxiliary shaft 30 in gear with the driving pinion 13 of the ratio III. This auxiliary shaft 30 supports a first power transfer indicated as T1 including a pair of pinions 34, 36, including a pinion 34 that can become interdependent to the auxiliary shaft 30 via the displacement of a sliding synchronisation sleeve 40, and another pinion 36 connected to the external primary shaft 2.

Through the engagement of the power transfer T1, the two primary shafts are connected in rotation, the ratios of the two pairs of pinions 13, 32 and 34, 36 of this T1 connection being chosen so that the speed of the internal primary shaft 4 is reduced with regards to the one of the external primary shaft 2 according to a ratio called ratio T1.

The gearbox 1 includes in addition a second power transfer indicated as T2 including a pair of pinions 42, 44, the pinion 44 is connected to the external primary shaft 2, the pinion 42 can be connected in rotation to the auxiliary shaft 30 via the sliding sleeve 40.

Starting from a rotation of the external primary shaft 2, the pairs of pinions 34, 36 and 42, 44 of the power transfers T1 and T2 are chosen so that the power transfer T2 produces a lower speed of the auxiliary shaft 30 than the one produced by the power transfer T1, i.e. the power transfer T2 driving the internal primary shaft 4 achieves a higher speed reduction than the power transfer T1.

On the auxiliary shaft 30, a pinion 48 is supported by the hub of the pinion 42 and can be connected to it via a sliding sleeve 46, this pinion 48 is in gear with a pinion 50 mounted on a free rotating shaft, which itself is in gear with the driving pinion 11 of the ratio I. The movement is transferred coming from the engine by the clutch C1, the pair of pinion 44, 42, then by the pinions 48, 50 and 11 to achieve an inversion of the running direction of the secondary shaft 10 supplying a reverse gear ratio.

The pinions are axially arranged starting from the clutches C1, C2 in following order, the pair of pinion 34, 36 of the power transfer T1 that is at least partially transversally aligned with the output pinion 6, the ratio II then the ratio IV with the sleeve 22 fitted in between, the pair of pinion 42, 44 of the second power transfer T2, the ratio I then the ratio III with the sleeve 16 fitted in between.

It is to be noted that the sleeves 40, 46 are more or less transversally aligned with respectively the sleeves 22, 16, however the transversal distances between the primary shafts 2, 4 and on one hand the secondary shaft 10, or on the other hand the auxiliary shaft 30, can be reasonably reduced, the sleeves having a rather high external diameter but not being arranged on two nearby shafts directly connected together by a pair of pinions.

The table of FIG. 2 presents an operation of the gearbox of FIG. 1, it includes a first column 60 indicating the speed indicated from 1 to 9, a second column 62 indicating the ratios engaged by the clutch C1 and a third column 64 indicating the ratios engaged by the clutch C2.

The first speed is brought into operation by engaging the ratio I and the power transfer T2, then the clutch C1 is gradually closed to start the vehicle, the torque is successively transferred by two ratios, the power transfer T2 and the ratio I.

The shifting of the second speed is done by gradually switching the engine torque from the external primary shaft 2 to the internal primary shaft 4 by closing the clutch C2 and simultaneously opening the clutch C1. The ratio I remains engaged but with a higher speed of the internal primary shaft 4 that is the one of the engine. At the end of the shift, the power transfer T2 can be disengaged. This shift without torque break is presented in the table by a continuous line.

For the shift into third speed, the ratio II is engaged then the engine torque is gradually switched from the clutch C1 to the clutch C2. At the end of the shift, the ratio I can be disengaged.

The shift into fourth speed is prepared by engaging the ratio III, then the engine torque is temporarily switched from the clutch C2 to the clutch C1. Then the ratio II is disengaged, the power transfer T2 is engaged, and finally the engine torque is switched back the other way from the clutch C2 to the clutch C1. We then use the ratio III with a speed reduction of the internal primary shaft 4.

The transient shift through the ratio III can be achieved by controlling a slipping of the clutch C2 so to keep an engine speed higher or equal to the one that will be reached on the fourth speed. When the engine torque is switched back from clutch C2 to clutch C1, clutch C1 can complete the synchronisation of the engine speed if it has not been completed before by the clutch C2.

This way, the speed shift is gradual with a steady and continuous reduction of the engine speed, the temporary shift through the ratio III is not perceptible by the driver, the performances are not reduced by a drop followed by a rising of the speed of the engine flywheel that would dissipate energy and would brake the vehicle.

The shift of the fifth speed is done by temporarily applying the torque on the ratio III by tightening the clutch C2 whilst maintaining a slip, then the power transfer T2 is disengaged, and the torque is switched back from the clutch C2 to the clutch C1. Likewise, a slip of the clutch C2 allows achieving a steady and continuous drop of the engine speed.

The shift of the sixth speed corresponding to the directly used ratio III is done by switching the torque from the clutch C1 to the clutch C2. The shift of the seventh speed corresponding to the directly used ratio IV is performed by engaging the ratio IV and by switching the torque from the clutch C2 to the clutch C1.

The shift of the eighth speed is done by engaging the power transfer T1 then by switching the torque from the clutch C1 to the clutch C2. The ratio IV is used with the power transfer T1 is series, which gives in this case a speed increase of the external primary shaft 2 with regards to the one of the engine.

The ninth speed using the ratio IV with the power transfer T2 giving a higher speed increase of the external primary shaft 2 with regards to the speed of the engine, can be shifted several ways.

The first way is directly from the seventh speed by keeping the engine torque applied to the wheels, the power transfer T2 is engaged then the engine torque is switched from the clutch C1 to the clutch C2. The second way is achieved from the eighth speed by keeping the engine torque applied to the wheels, by transitory going through the seventh speed via a switch from the clutch C2 to the clutch C1, then the power transfer T1 is disengaged, the power transfer T2 is engaged and the engine torque is switched back from the clutch C1 to the clutch C2. In this case, the transient shift through the seventh speed leads to an increase of the engine speed that is limited because the differences between these speeds are reduced, and because these ratios providing a high speed increase are generally used with rather low engine rotational speeds.

A third way for shifting from the eighth speed to the ninth can be done with a torque break, the clutch C2 is open, the power transfer T1 is disengaged, the transfer T2 is engaged, then the clutch C2 is closed.

A special use of this last speed consists in engaging it to reduce the rotation speed of the engine and therefore its braking power when, starting from the two previous speeds, with an enough high vehicle speed, the driver has released the throttle. The shift of this gear will not be perceived by the driver because it happens with absence of an engine torque. At the first request on the throttle, the gearbox goes back to the seventh speed to give enough traction force, then if needed to the eighth speed without break in the traction torque.

The downshifts of the speeds are also achieved without torque break, by inverting the order of the operations. The shift from the fifth to the fourth (or from the fourth to the third speed) temporarily uses the ratio III, the engine torque is switched from the clutch C1 to the clutch C2 by controlling the slip of the clutch C2 to achieve a continuous rising of the engine speed without overshooting the speed it will reach on the fourth (or the third) speed. Then the power transfer T1 (or T2) is disengaged, the power transfer T2 (or the ratio II) is engaged and finally the torque is switched back from the clutch C2 to the clutch C1.

The gearbox 1 allows to quickly downshifting several speeds starting from the ninth or eighth speed, without engaging any ratio to go to the seventh speed, then with a single engagement to shifting to the sixth speed, and finally with only one engagement to shifting to the fifth, the fourth or the third speed.

A direct shift from the seventh to the second speed represented in the table with an interrupted line also requires only one engagement, the ratio I, then it performs via a switching from the clutch C1 to the clutch C2. Besides, it is possible during the driving on a speed to keep a ratio engaged as anticipation that would be used to downshift one or several speeds depending on the request probability of the driver, so to reduce the shifting time should this happen.

The gear range of this gearbox is interesting. By choosing a rather low value for the reduction ratio of the power transfer T1, included between 1,15 and 1,30 for example, and a similar value for the speed difference between the ratios III and IV, we achieve a rather close series of differences between the fifth and the eighth speed. The differences between the third and the fourth as well as between the second and the third speed are freely chosen with higher values.

Between the first and the second speed, the power transfer T2, with for example a reduction ratio included between 1,40 and 1,80, achieves a high difference. In addition, the fifth or eighth speed are fitted in between two speeds which value difference is also given by the power transfer T2, which limits the differences for the series of higher speeds.

This gearbox 1 especially suits a mounting at the end of an engine transversally installed in a vehicle between the wheels, which limits the available length, the reduced number of sleeves and pinions providing it with a low axial length. The gearbox can achieve up to nine speeds and a reverse gear by using only 4 synchronisation sleeves and one single output shaft, which represents a simple, compact and cost efficient realisation compared to a classical solution that requires at least one sleeve for two speeds, and two output shafts.

On the gearbox 101 presented in FIG. 3, the ratios II and IV are arranged on the internal primary shaft 102 driven by the clutch C1, while the ratios I and III are arranged on the external primary shaft 104 driven by the clutch C2, the positions of the two clutches are therefore inverted in comparison to the FIG. 1. We have successively axially starting from the clutches, the output pinion 106, the ratios I and III with the control sleeve 116 in between, then the ratios II and IV with the control sleeve 122 in between.

The auxiliary shaft 130 is connected in rotation with the internal primary shaft 102 by a pair of pinion 150, 152 respectively connected to these shafts, and axially located between the gears II and III. Its reduction ratio can be chosen independently from the other gearbox ratios.

The auxiliary shaft 130 supports a pinion 134 that can be made interdependent via a sliding synchronisation sleeve 154, which is in gear with a second pinion 136 connected to the external primary shaft 104. These pinions are axially arranged between the clutches and the first ratio I, at least partially aligned with the output pinion 106. By engaging this pinion 134, we achieve a power transfer T1 between the two primary shafts rotating in the same direction following a reduction ratio T1 equal to the product of the reduction ratios of the two pairs of successive pinions, 152,150 and 134,136.

The auxiliary shaft 130 supports another pinion 142 that can be made interdependent via a sliding synchronisation sleeve 156, which is in gear with the driving pinion 113 of the third ratio III. Identically, by the engagement of this pinion 156, we achieve a power transfer T2 between the two primary shafts rotating in the same direction following a reduction ratio T2 equal to the product of the reduction ratios of the two pairs of successive pinions, 152, 150 and 142, 113.

The sleeve 156 for engaging the power transfer T2 is also used to engage the reverse gear R by connecting in rotation a pinion 148 to the auxiliary shaft 130 that supports it. This pinion 148 is in gear with a pinion 144 free in rotation, itself in gear with the driving pinion 111 of the ratio I, the interposition of an additional pinion 144 achieving an inversion of the running direction.

The gearbox 161 presented in FIG. 4 is similar to the one of FIG. 3, but the driving of the auxiliary shaft 130 by the internal primary shaft 102 differs, it is achieved by the driving pinion 117 of the ratio II which in gear with the pinion 150 connected to the auxiliary shaft 130. The driving pinion 117 being common for the ratio II and the driving of the auxiliary shaft 130, we have a pinion less and the gearbox is axially shorter.

On the other hand, the ratio of the power transfer T2 is fixed, it is more or less equal to the ratio difference between the ratios II and III. However, by modifying the distance between the auxiliary shaft 130 and the primary shafts 102, 104, we get an adjustment parameter of this ratio.

The positions of the power transfers T1, T2 can be exchanged, the synchronisation sleeve 156 of the reverse gear R being then used for engaging the power transfer T1. However, the pinion 136 connected to the external primary shaft 104 would in this case have a bigger diameter, which can harden its layout especially regarding the output pinion 106.

It is to be noted that the synchronisation sleeve 154 of the power transfer T1 is located at the end of the auxiliary shaft 130, axially between the clutches and the controlled pinion 134, and transversally aligned with the output pinion 106 this has the advantage not to increase the axial length of the gearbox.

In addition, the auxiliary shaft 130 does not axially lie beyond the driving pinion 117 of the internal primary shaft 102, it is therefore shorter than the other shafts leaving a free space at the rear of the gearbox that allows to placing more easily some components, especially components of the vehicle body. This short shaft is lighter, less expensive, and has a reduced flexion that allows to improving the efficiency and the operating noise of the train of gears.

Besides this, the auxiliary shaft being only connected to the primary shafts, its position can vary while keeping the distance between those shafts, following an arc of circle, which helps for its layout.

Another advantage of the gearbox 101, 161 is that the driving pinion 111 of the most reduced ratio I transferring the highest force, is located on the external primary shaft 104 nearest to the supporting bearings of the primary shafts located next to the clutches, which reduces the constraints on the shafts.

According to a non represented variant, the pinion 150 connected to the auxiliary shaft 130 is in gear with the driving pinion 117 of the second ratio II, and the pinion 142 of the second power transfer T2, supported by the auxiliary shaft, is in gear with a pinion connected to the external primary shaft 104. This way, the two pinions of the two power transfers T1, T2 connected to the external primary shaft 104 can have a reduced diameter that helps their layout, especially regarding the output pinion 106.

The FIGS. 5 and 7 show two combination examples achievable with a gearbox with two power transfers T1, T2, the FIGS. 6 and 8 show some examples of reduction values for the speeds, feasible respectively from FIGS. 5 and 7.

The FIG. 5 shows an operating mode of the previous gearboxes, the column 160 includes seven speeds indicated as 1 to 7, plus a speed indicated as 2−, the second column 162 the state of the clutch C1, 0 for opened and 1 for closed, the third column 164 the state of the clutch C2, and the fourth column 166 the engaged ratios and transfers.

The first speed uses the ratio I in combination with the power transfer T2 providing a high speed reduction of the primary shaft linked to this ratio, it is used for the starting from rest of the vehicle. The speeds from the second to the fifth directly use the ratios I to IV. The sixth speed uses the ratio IV in combination with the power transfer T1 that provides a rotation speed increase of the primary shaft linked to this ratio, the seventh speed also uses the ratio IV with the power transfer T2 that provides a higher speed increase. The shifts of these two last ratios can be done like those described for the FIG. 2.

An additional speed indicated as 2− is inserted between the first and the second speed, it uses the ratio I in combination with the power transfer T1 which provides a less high speed reduction than for the first speed. The shift into this speed indicated with an interrupted line is performed from the second speed, by engaging the power transfer T1, then by switching the torque from the clutch C2 to the clutch C1.

A possible use of this additional 2− speed is the following. The vehicle driving in the second speed, during a significant speed reduction without however reaching standstill, for example when the vehicle is turning at crossroads in town at less than 10 km/h, the designer of a classical gearbox has the choice between either plan to shift back to the first speed, which, requiring a high synchronisation time and a boosting of the engine at much higher rotation speed, is slow and uncomfortable given the reduction difference between the first and the second speed, in addition few time later the second speed is again to be shifted, or plan to remain in the second speed.

In this last case, if the engine rotation speed decreases too much the engine turns more and more uneven which is uncomfortable and can damage the engine and its components, we are obliged to plan a slip of the clutch C2 to keep the rotation speed high enough. The energy dissipated in the clutch, the heating-up and the wear are then as high as the speed difference is significant. In addition, the torque is not multiplied.

The 2− speed is attractive, the quick and comfortable shift allowed by a little difference provides a more reduced speed than the second speed allowing some manoeuvres that can also be performed with a reduced slip of the clutch C2. If the vehicle still slows down almost arriving at standstill, the first speed is engaged to prepare the next starting from rest. On the other hand if the driver accelerates, the shift to the second speed is performed smoothly thanks to the rather low reduction ratio difference, the speed 2− allows more significant vehicle accelerations than with the second speed, without the time losses caused by the shifting into the first speed.

During a rather slow driving in second speed, it is possible to engage the power transfer T1 with anticipation to quickly provide a strong acceleration in case of demand, by instantaneously switching the torque from the clutch C2 to the clutch C1. This quick answer is a safety item when, for example, a prompt drive-out of crossroads is needed to avoid another vehicle.

Moreover, this 2− speed can also be a starting speed of the vehicle in special conditions like on slippery road, the reduced torque supplied to the wheels decreasing the spinning risk.

The FIG. 6 shows a realisation example of the operating mode presented in FIG. 5, the column 170 shows reduction values of the speeds, the column 172 the difference between each speed with at the bottom the total difference between the first and the last speed. Preferably, we have a gradual reduction of the differences from the first to the sixth speed. To do so, the power transfer T2 has a higher reduction ratio (1,60) than the difference between the first and the second speed (1,50).

In addition, the reduction ratio of the power transfer T2 (1,60) is more than twice higher than the one of the power transfer T1 (1,22), which leads to a higher difference between the sixth and the seventh speed than between the fifth and the sixth, the last speed being a very reduced speed allowing to drive quickly with a rather slow engine rotation to reduce its consumption.

The FIG. 7 shows as a variant an operating mode with 8 speeds, including an additional speed, the fourth, using the ratio III is series with the power transfer T1. The shift from the third speed to the fourth speed includes a temporary use of the ratio III directly used as indicated in FIG. 2, it is achieved after having engaged the ratio III, by temporarily applying the torque on this ratio by tightening the clutch C2, then the ratio II is disengaged, the power transfer T1 is engaged and the torque is switched back from the clutch C2 to the clutch C1. A slip can be maintained on the clutch C2 to achieve a steady and continuous drop of the engine speed during the gearshift without falling below the rotation speed that will be reached when using the fourth speed.

However, the ratio III only used in combination with the power transfer T1 allows to limiting the friction energy of the clutch C2.

The FIG. 8 shows a realisation example of the operating mode presented in FIG. 7. It is to be noted that the difference between the fifth and the sixth speed (1,23) is approximately equal to the reduction ratio of the power transfer T1, which allows to achieving a more or less constant series of differences from the fourth to the seventh speed.

As for the FIG. 6, the reduction ratio of the power transfer T2 (1,59) can be more than twice higher than the one of the power transfer T1, which leads to a higher difference between the seventh and the eighth speed than for the three previous differences, achieving a very reduced last speed.

A higher number of speeds allows to increasing the total difference from the first to the last one, which can be higher than 8, to achieving a very reduced first speed or very multiplied higher speeds. Moreover we can also achieve closer speeds.

The gearbox 201 shown in FIG. 9 includes the following variants, two secondary shafts 210, 211 are each connected to an output pinion 206, 207 transversally aligned, and the internal primary shaft 102 has its two driving pinions 117,119 axially side by side.

The first output shaft 210 only supports two driven pinions 112, 114 with the synchronisation sleeve 116 in between, to achieve the ratios I and III. The same way, the second output shaft 211 only supports two driven pinions 218, 220 axially side by side, the synchronisation sleeve 222 is shifted outside the two pinions side by side next to the output pinion 207. The driven pinion 220 the most away from the sleeve 222 includes a hub that goes throughout the driven pinion 218, then through the sleeve 222, to join up its synchronisation components that are in front of the axial end of the sleeve, opposite to the pinions. The synchronisation components are bypassed by a part of the sleeve 222 radially going through the outside, to allow connecting this sleeve to splines 223 for rotational connection to the secondary shaft 211.

This variant only includes one sleeve and two driven pinions for each secondary shaft, is axially very short with stiffer shafts, it can more easily be installed in a vehicle providing a transversal installation of the engine.

The FIG. 10 shows a gearbox with an output secondary shaft 358 aligned with the engine shaft, which can operate according to operating modes defined before.

Axially and starting from the clutches, we find a pair of pinion 360, 362 connecting in rotation an external primary shaft 350 driven by the clutch C1 and a full auxiliary shaft 354, two pairs of pinions 390, 392 and 394, 396 that can connect an internal primary shaft 352 driven by the clutch C2 to the full auxiliary shaft 354 via the control of a sleeve 398 axially installed between these pairs, to achieve two power transfers respectively T1, T2. The pinion 396 is connected to a hollow auxiliary shaft 356 surrounding the full auxiliary shaft 354.

A sleeve 374 can connect in rotation the end of the internal primary shaft 352 to the one of the output secondary shaft 358 so to achieve a ratio III, a pair of pinion 370, 372 can connect in rotation the hollow auxiliary shaft 356 to the secondary shaft 358 via the control of the sleeve 374 to achieve a ratio indicated as I.

A sleeve 368 can connect in rotation a pinion 386 with the other full auxiliary shaft 354, this pinion 386 being in gear through a pinion 390 mounted on a free rotating shaft with a pinion 388 connected to the secondary shaft 358 so to achieve a reverse gear ratio indicated as R. And finally two pairs of pinions 376, 378 and 380, 382 can connect in rotation the full auxiliary shaft 354 to the secondary shaft 358 via the control of a sleeve 384 axially installed between theses pairs.

The power transfers T1, T2 allow to connecting in rotation the internal primary shaft 325 to the external primary shaft 350, the power transfer T2 giving a smaller speed to the internal primary shaft 352 than the one given by the power transfer T1. This way, we have two possible speed reductions for ratios I and III by using the clutch C1, and two possible speed increases for ratios II and IV by using the clutch C2.

It is to be noted that for the various variants shown, the power transfers T1 and T2 are engaged through the movement of a single sleeve that simplifies the control and reduces the costs.

Generally speaking, other variants can be achieved by modifying the combinations between the ratios and the transfers, 12 speeds can be achieved in sum by using three times each ratio, the speed shifts being achieved with or without torque break. The clutches can use various technology, working dry or in oil. Each one can include its own torsional vibration damping device, or a single damper device can be mounted upstream between the clutches and the engine.

Interesting applications of the invention are feasible for various vehicles, like light duty, commercial, four-wheel-drive or agricultural vehicles.

1. A gearbox comprising a first and a second primary shaft using a common axis, respectively linked to a first and second clutch coupled to an engine, and at least a secondary shaft linked to an output device of the gearbox, the second primary shaft can be linked in rotation to a secondary shaft by the engagement of a first (I) and third ratio (III), the first primary shaft can be linked in rotation to a secondary shaft by the engagement of a second (II) and fourth ratio (IV), these directly used ratios achieving four speeds of the gearbox, and following their order successively achieving a higher and higher speed increase of the output component's speed, characterised in that the primary shafts can be connected in rotation together according to a same rotational direction thanks to the engagement of two power transfers, each one being activated by the engagement of a single synchronisation sleeve, the first power transfer achieving from a rotation of the first primary shaft a speed reduction of the second primary shaft, the second power transfer achieving a bigger speed reduction of the second primary shaft.

2. The gearbox according to the claim 1, characterised in that the second power transfer provides a speed reduction at least twice higher than the one provided by the first power transfer.

3. The gearbox according to the claim 1, characterised in that the two power transfers are combined with the fourth ratio (IV) to achieve respectively a first additional speed providing a high increase of the rotation speed, and a second additional speed providing a higher speed increase than the first speed.

4. The gearbox according to the claim 3, characterised in that for an indirect shift from the additional first speed to the additional second speed, the engine torque is switched from one clutch to the other for a transient operation through the directly used fourth ratio (IV), then the first power transfer is disengaged, the second power transfer is engaged, and finally the engine torque is switched back between the clutches the other way round, the engine being able to permanently supply a driving torque to the driving wheels.

5. The gearbox according to the claim 3, characterised in that for a direct shift from the first additional speed to the second additional speed, the clutch transferring the torque is opened, then the first power transfer is disengaged, the second power transfer is engaged, and finally the same clutch is closed again.

6. The gearbox according to the claim 5, characterised in that a shift from the fourth directly used ratio IV or from the first additional speed, to the second additional speed is achieved when, starting from a given vehicle speed, the driver has released the throttle.

7. The gearbox according to claim 6, characterised in that the two power transfers are combined with the first ratio (I) to achieve respectively a first additional speed providing a high speed reduction and a second additional speed providing a higher speed reduction than the first one.

8. The gearbox according to the claim 7, characterised in that the vehicle driving in the directly used first ratio, the first additional speed is engaged when the vehicle speed decreases below a given threshold, while the second additional speed is engaged when the vehicle is almost at standstill.

9. The gearbox according to claim 8, characterised in that the third ratio is used in combination with the first power transfer to supply an additional intermediate speed between the directly used second (II) and third (III) ratios, the shift process from the second ratio (II) to the intermediate speed successively including following operations, the third ratio (III) is engaged, the engine torque is switched from the first primary shaft to the second primary shaft by simultaneous at least partial closing of the clutch of the second primary shaft and opening of the clutch of the first primary shaft, the reduction ratio (II) of the first primary shaft is disengaged, the power transfer is engaged and finally the engine torque is switched back from the second primary shaft to the first one by simultaneous closing of the first clutch and opening of the second clutch.

10. The gearbox according to claim 9, characterised in that the external primary shaft including a longitudinal boring supports the driving pinions of the first (I) and the third ratio (III), the second internal primary shaft going through the external primary shaft supports the driving pinions of the second (II) and the fourth (IV) ratio.

11. The gearbox according to the claim 10, characterised in that the synchronisation sleeves supported by the auxiliary shaft and achieving the engagement of the power transfers are laterally aligned with the external primary shaft.

12. The gearbox according to claim 11, characterised in that the driving pinion of the second ratio (II) is used to drive the auxiliary shaft, the driving pinion of the third ratio (III) can be used to achieve the second power transfer.

13. The gearbox according to claim 12, characterised in that it includes a first secondary shaft driven by the first (I) and the third (III) ratio, and a second secondary shaft driven by the second (II) and the fourth (IV) ratio.

14. The gearbox according to claim 13, characterised in that it is axially fixed at the end of an engine, this system being transversally installed between the front driving wheels of a vehicle.

15. The gearbox according to claim 14, characterised in that the secondary shaft is axially aligned with the primary shafts.
